(19) United States
(12) Patent Application Publication
(10) Pub. No.: US 2014/0184451 A1
(43) Pub. Date: Jul. 3, 2014

(54) HANDHELD DEVICE

(71) Applicant: HTC Corporation, Taoyuan County (TW)

(72) Inventor: Yen-Liang Kuo, Taoyuan County (TW)

(73) Assignee: HTC Corporation, Taoyuan County (TW)

(21) Appl. No.: 14/155,365

(22) Filed: Jan. 15, 2014

Related U.S. Application Data
(63) Continuation-in-part of application No. 12/768,736, filed on Apr. 28, 2010, now Pat. No. 8,665,159.

(30) Foreign Application Priority Data
Oct. 9, 2009 (TW) 98134312

(51) Int. Cl. H01Q 1/24

(52) U.S. Cl. CPC H01Q 1/242
USPC 343/702

(57) ABSTRACT

A handheld device at least including a functional element, an appearance and a planar antenna is provided. The appearance at least includes a communicating space. In addition, the communicating space passes through the appearance, and the communicating space is a channel for transmitting signals from the functional element, or the communicating space is configured to expose the functional element. The planar antenna is disposed on an external surface of the appearance, and extended to an internal surface of the appearance through the communicating space.

### CROSS-REFERENCE TO RELATED APPLICATION

This application is a continuation-in-part application of and claims the priority benefit of U.S. application Ser. No. 12/768,736, filed on Apr. 28, 2010, now allowed, which claims the priority benefit of Taiwan application serial no. 98134312, filed on Oct. 9, 2009. The entirety of each of the above-mentioned patent applications is hereby incorporated by reference herein and made a part of this specification.

### BACKGROUND OF THE INVENTION

1. Field of the Invention

The invention generally relates to a handheld device, and more particularly, to a handheld device having a planar antenna.

2. Description of Related Art

In recent years, wireless communication has gradually become the major communication method adopted by the public, and diversified wireless communication devices, such as smart phones, multimedia players, personal digital assistants (PDAs), and satellite navigators, have been provided. In addition, the design of electronic devices with wireless transmission function is going towards light weight and small size so that electronic devices suitable for daily use can be provided. In particular, an antenna is one of the most indispensable elements in a wireless communication system and critical to the performance of the entire system.

For instance, a planar antenna is usually adopted in a mobile phone in order to reduce its size. The planar antenna is disposed in a housing or a cover and accordingly it may be affected by other elements (for example, a speaker, a battery, or a connector) of the cell phone. In addition, the height/volume of the clearance to the planar antenna is another major factor. Namely, the higher the clearance of the planar antenna, the better the performance of the planar antenna.

However, since there is very limited space in a mobile phone, it is very difficult to increase the height of the clearance to the planar antenna in the mobile phone.

### SUMMARY OF THE INVENTION

Accordingly, the invention is directed to a handheld device, wherein the signal receiving quality of a planar antenna in the handheld device is improved.

The invention is directed to a handheld device including a functional element, an appearance and a planar antenna. The appearance includes a communicating space. In addition, the communicating space passes through the appearance, and the communicating space is a channel for transmitting signals from the functional element, or the communicating space is configured to expose the functional element. The planar antenna is disposed on the appearance, and extended to an internal surface of the appearance through the communicating space.

From another perspective, the invention is directed to a handheld device including a first appearance, a second appearance and a planar antenna. The second appearance is engaged with the first appearance to form an accommodating space. In addition, a side portion of the first appearance and a side portion of the second appearance have a gap therebetween. The planar antenna is disposed on an external surface of the first appearance, and extended to an internal surface of the first appearance through the gap.

In view of the foregoing, in the invention, the planar antenna is integrated with the appearance, and the appearance has the communicating space disposed on the basis of the functional element or has a gap. As such, the planar antenna may be extended to an internal surface of the appearance through the communicating space or the gap of the appearance, and thus the signal reception quality is improve and the fabrication process of the handheld device is simplified.

The abovementioned features, aspects, and advantages of the invention will become more obvious and better understood with regard to the following description of the embodiments, appended claims, and accompanying drawings in the below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an appearance and a planar antenna according to a first embodiment of the invention.

FIG. 2 is a side view of the appearance and the planar antenna in FIG. 1.

FIG. 3 is a side view of an appearance and a planar antenna according to a second embodiment of the invention.

FIG. 4 is a side view of an appearance and a planar antenna according to a third embodiment of the invention.

FIG. 5 is a top view of an appearance and a planar antenna according to a fourth embodiment of the invention.

FIG. 6 is a top view of an appearance and a planar antenna according to a fifth embodiment of the invention.

FIG. 7 is a top view of the appearance and the planar antenna in FIG. 6 after they are painted.

FIG. 8 is a side view of a handheld device according to another embodiment of the invention.

FIG. 9 is a front view of a handheld device according to an embodiment of the invention.

FIG. 10A and FIG. 10B respectively are back views of a handheld device according to an embodiment of the invention.

FIG. 11 is a side view of a handheld device according to another embodiment of the invention.

FIG. 12 is a front view of a handheld device according to another embodiment of the invention.

### DESCRIPTION OF THE EMBODIMENTS

Conventionally, a small volume and a good performance cannot be achieved at the same time in a cell phone.

In embodiments of the invention, a planar antenna (a planer inverted-F antenna (PIFA)) is disposed on an appearance of a handheld device through a coating technique (for example, a molded interconnect device (MID)) technique or a laser direct structuring (LDS) technique), wherein the appearance may be a sound hole cover of a speaker. After that, a conductive metal liquid is filled through a hole on the sound hole cover from an external surface of the appearance, so as to form a ground area and a feed area on an inner surface of the appearance. Thus, a radiating body of the planar antenna located on the external surface of the appearance is electrically connected to the ground area and the feed area on the inner surface of the appearance. Next, the planar antenna is electrically connected to a substrate (including a system ground plane, a RF circuit, and a matching circuit) by using a spring or a pogo pin. This planar antenna has a creative structure, and since the PIFA does not require a large clearance, other elements (for example, the speaker) can be disposed below the PIFA. Accordingly, both internal and external spaces taken by the planar antenna are reduced, and the requirements in the appearance, ID design, fabricating cost, and signal receiving effect of the mobile phone can all be met. Reference will now be made in detail to the present preferred embodiments of the invention, examples of which are illustrated in the accompanying drawings. Wherever possible, the same reference numbers are used in the drawings and the description to refer to the same or like parts.

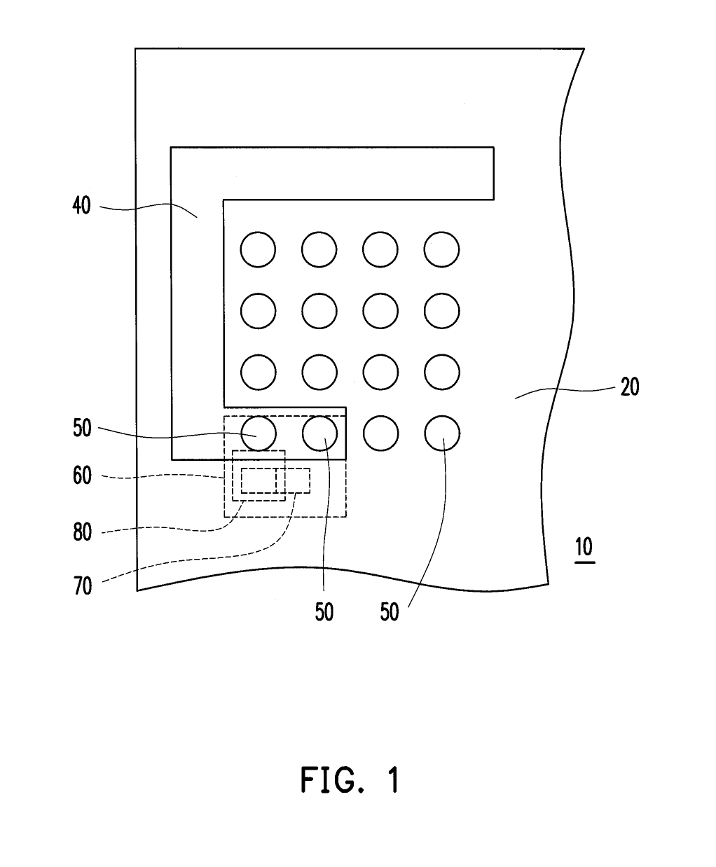

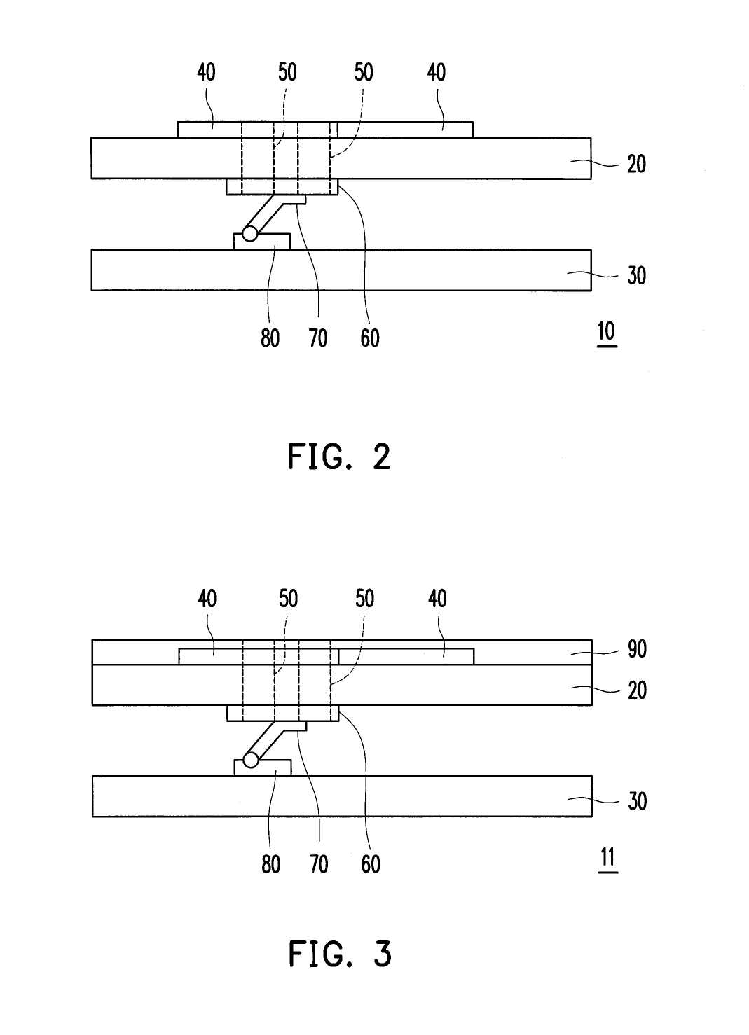

FIG. 1 is a top view of an appearance and a planar antenna according to a first embodiment of the invention, and FIG. 2 is a side view of the appearance and the planar antenna in FIG. 1. Referring to both FIG. 1 and FIG. 2, the handheld device 10 includes an appearance 20, a system ground plane 30, and a planar antenna 40. In the present embodiment, the handheld device 10 is a mobile phone, but the invention is not limited thereto.

The appearance 20 is described as a sound hole cover of a speaker, but the invention is not limited thereto. The appearance 20 has a plurality of vias 50. In the present embodiment, there are sixteen vias 50, and in other embodiments, there may also be one or other numbers of vias 50. Further, those vias can be arranged randomly, and the present embodiment is not limited to the rectangular pattern. In the present embodiment, the vias 50 are conductive vias, and which can not only be used for electrically connecting the planar antenna 40 and a metal layer 60 but also be served as sound holes.

The system ground plane 30 is disposed inside the appearance 20. In the present embodiment, the planar antenna 40 is a monopole antenna such that a feeding point 80 is disposed on the system ground plane 30. The feeding point 80 is electrically connected to the metal layer 60 through a conductive element 70, wherein the conductive element 70 may be a spring. Accordingly, the planar antenna 40 is electrically connected to the feeding point 80 of the system ground plane 30 through the vias 50, the metal layer 60, and the conductive element 70. In addition, by disposing the conductive element 70, the electrical connection between the planar antenna 40 and the system ground plane 30 is not damaged when the appearance 20 is disassembled, and the electrical connection between the planar antenna 40 and the system ground plane 30 is re-established through the conductive element 70 when the appearance 20 is assembled back to the handheld device 10. On the other hand, the planar antenna 40 can be a PIFA equipped with a feeding point 80 on the system ground plan and also a ground point (not shown) for grounding function.

It should be mentioned that in the present embodiment, the planar antenna 40 is integrated with the appearance 20. For instance, the planar antenna 40 is disposed on the appearance 20 through a coating technique, wherein the coating technique may be a molded interconnect device (MID) technique or a laser direct structuring (LDS) technique. Accordingly, the planar antenna 40 itself does not occupy any space in the handheld device 10. In other words, the handheld device 10 can have more internal space for accommodating other elements. For instance, a speaker (not shown) may be disposed below the vias 50. In order to have better performance, the planar antenna can be replaced with a PIFA. In different embodiments, other elements may also be disposed by those skilled in the art according to the actual requirements.

In addition, the performance of the planar antenna 40 can be improved by integrating the planar antenna 40 with the appearance 20. It should be understood by those skilled in the art that the higher the clearance of the planar antenna 40 is, the better performance the planar antenna 40 has. The planar antenna disposition technique provided by the present embodiment can increase the distance between the planar antenna 40 and the system ground plane 30 or other metal devices so that the performance of the planar antenna 40 can be effectively improved.

Noteworthily, even though a possible pattern of the disposition method of a planar antenna in a handheld device has been described in foregoing embodiment, it should be understood by those having ordinary knowledge in the art that because different manufacturer has different design regarding the handheld device and the disposition method of the planar antenna, and the application of the invention is not limited to the aforementioned pattern. In other words, it is within the scope of the invention as long as the planar antenna is integrated with an appearance and coupled to a system ground plane inside the appearance through vias of the appearance. In practical implementation, the appearance may be a cover of the handheld device or constitute a portion of the cover. Some other embodiments of the invention will be further described below so that those having ordinary knowledge in the art can understand the invention better and implement the invention according to the present disclosure.

In the first embodiment, the planar antenna 40 is a monopole antenna, but the invention is not limited thereto. In other embodiments, the planar antenna 40 may also be a PIFA or a planar antenna of another type. For instance, the planar antenna 40 may also be coupled to a ground point (not shown) on the system ground plane 30 through another via 50 of the appearance 20. However, this example will not be described herein.

In the first embodiment, the metal layer 60 is only a selected example, but the invention is not limited thereto. For instance, the metal layer 60 may also be replaced by a solder pad in another embodiment.

In the first embodiment, although the conductive element 70 is a spring, it is only a selected example, and the invention is not limited thereto. For instance, the conductive element 70 may also be a pogo pin in another embodiment.

In the first embodiment, the planar antenna 40 is disposed on an external surface of the appearance 20, but the invention is not limited thereto. FIG. 3 is a side view of an appearance and a planar antenna according to a second embodiment of the invention. The appearance and the planar antenna illustrated in FIG. 3 are similar to those illustrated in FIG. 2, and the difference between the two embodiments is that the handheld device 11 in FIG. 3 further includes a passivation layer 90. In the present embodiment, the passivation layer 90 covers the planar antenna 40 and the appearance 20. The passivation layer 90 may be paint, and which not only protects the planar antenna 40 from any damage but also prevents a user from touching the planar antenna 40 and accordingly affecting the performance of the planar antenna 40. Besides, the passivation layer 90 may be made of a transparent or a semi-transparent material so as to allow a user to see the shape of the planar antenna 40 and the handheld device 11 to have a modern look.

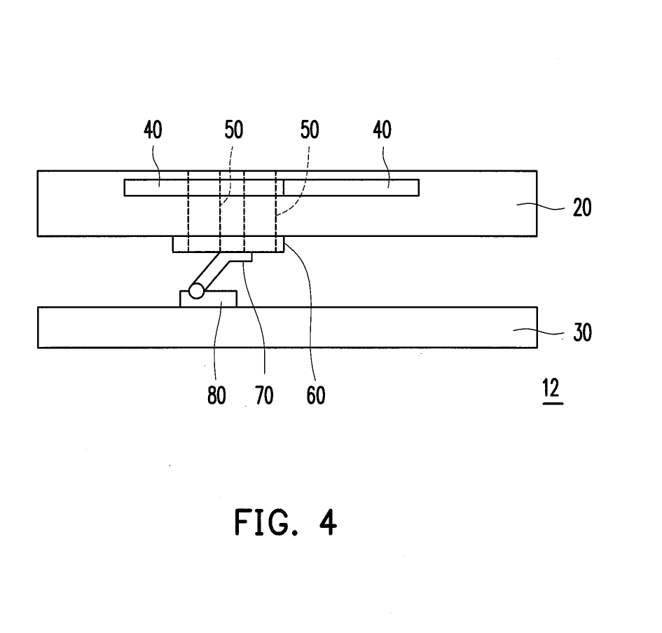

FIG. 4 is a side view of an appearance and a planar antenna according to a third embodiment of the invention. The appearance and the planar antenna illustrated in FIG. 4 are similar to those illustrated in FIG. 2, and the difference between the two embodiments is that the planar antenna 40 of the handheld device 12 is buried in the appearance 20. In the present embodiment, the planar antenna 40 is disposed on an intermediate layer of the appearance 20 through an injection molding technique. The appearance 20 may be made of a transparent or a semi-transparent material so that a performance similar to that described in the second embodiment can be achieved.

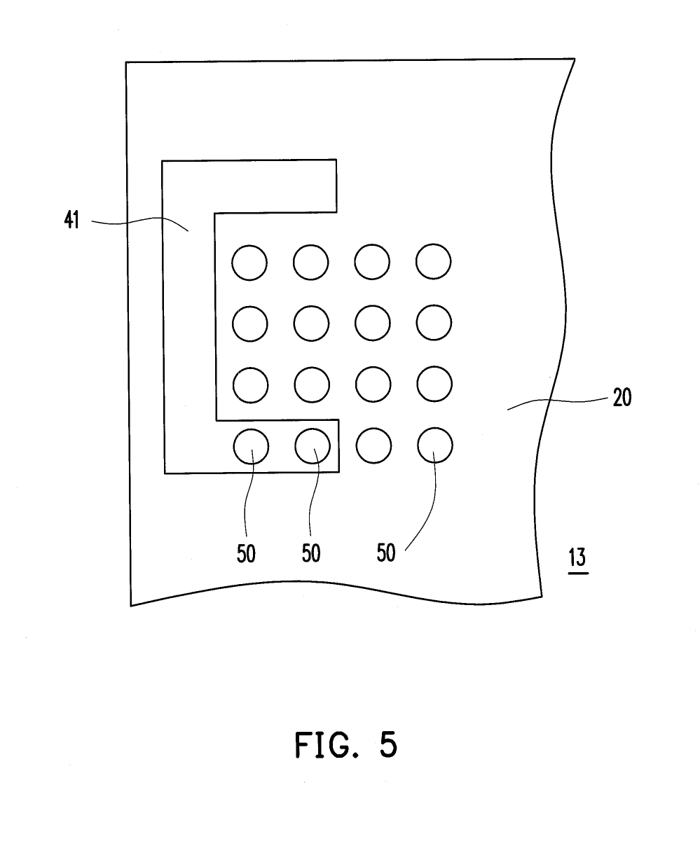

In addition, the shape of the planar antenna can be altered by those skilled in the art to allow the planar antenna to present a more meaningful or aesthetic pattern. FIG. 5 is a top view of an appearance and a planar antenna according to a fourth embodiment of the invention. The handheld device 13 illustrated in FIG. 5 is similar to the handheld device 10 illustrated in FIG. 1, and the difference between the two embodiments falls on the shapes of the planar antenna 40 and the planar antenna 41. In the present embodiment, the planar antenna 41 is designed to have a C shape, but the invention is not limited thereto. In other embodiments, the planar antenna may also be designed into other patterns by those skilled in the art according to the actual requirements.

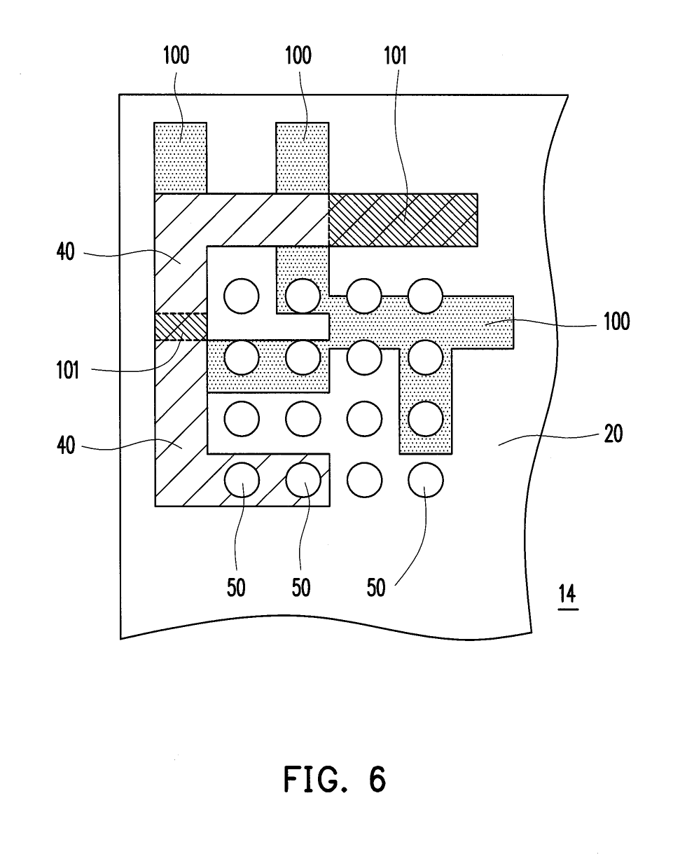

Moreover, the pattern of the planar antenna may also be decorated by those skilled in the art by using paint of different color. FIG. 6 is a top view of an appearance and a planar antenna according to a fifth embodiment of the invention. In the handheld device 14 provided by the present embodiment, the pattern of the planar antenna 40 is decorated by using a coating material (for example, paint) of different color. To be specific, the pattern of the planar antenna 40 can be extended by using a coating material 100, wherein the color of the coating material 100 is similar to the color of the planar antenna 40. In addition, the pattern of the planar antenna 40 may also be covered by using a coating material 101, wherein the color of the coating material 101 is similar to the color of the appearance 20.

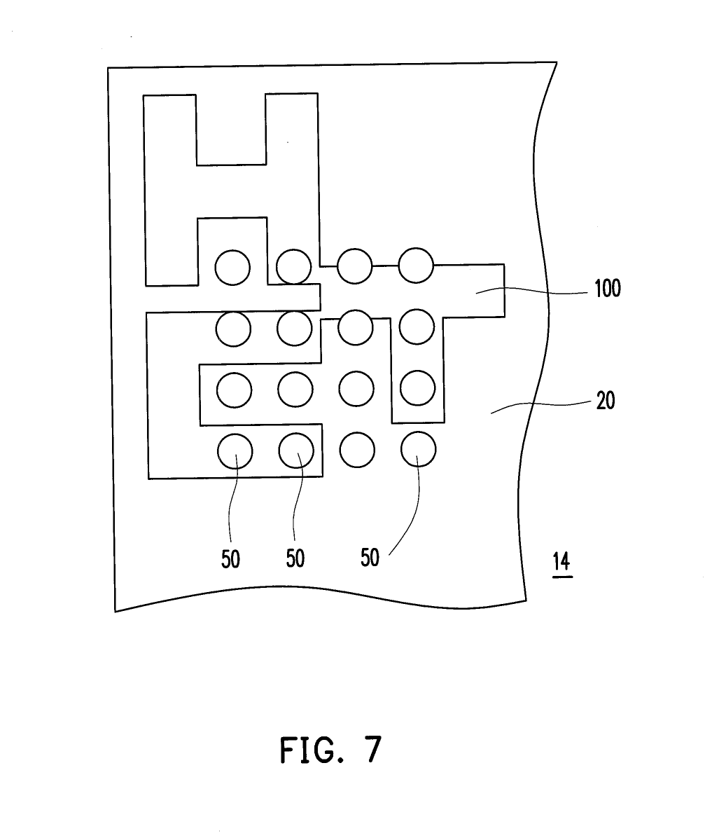

FIG. 7 is a top view of the appearance and the planar antenna in FIG. 6 after they are painted. After the planar antenna 40 is decorated by using the coating materials 100 and 101, the planar antenna 40 and the coating materials 100 and 101 present a pattern, HTC logo, as shown in FIG. 7. However, different patterns may also be achieved through the same technique by those skilled in the art but will not be described herein.

Referring to FIG. 1 and FIG. 2 again, the planar antenna 40 is disposed on the external surface of the appearance 20, and extended to the internal surface of the appearance 20 through the via 50 on the appearance 20, so as to be electrically connected to the feeding point 80 within the appearance 20. In addition, the via 50 is opposite to the speak (not shown) in the handheld device 10, and is used as the channel (e.g., sound-output hole) for transmitting signals from the speaker. In other words, the via 50 on the appearance 20, in addition to being used as the channel for transmitting signals from the speaker, may further be used as the communicating structure of the planar antenna 40.

Although the first embodiment has provided an implementation of the via 50, the invention is not limited thereto. In other words, the channel for transmitting signals, which is disposed on the appearance 20 and is opposite to a functional element, may be used as the communicating structure of the planar antenna 40. For instance, in another embodiment, the via 50 may, for example, be a sound-input hole. Namely, in another embodiment, the via 50 may, for example, be opposite to a microphone in the handheld device 10, and be used as a sound-input hole of the microphone. In other words, the communicating space may be a via or an open slot, etc. Any shape or style of channel passing through the appearance may be used as the means for implementing the communicating space.

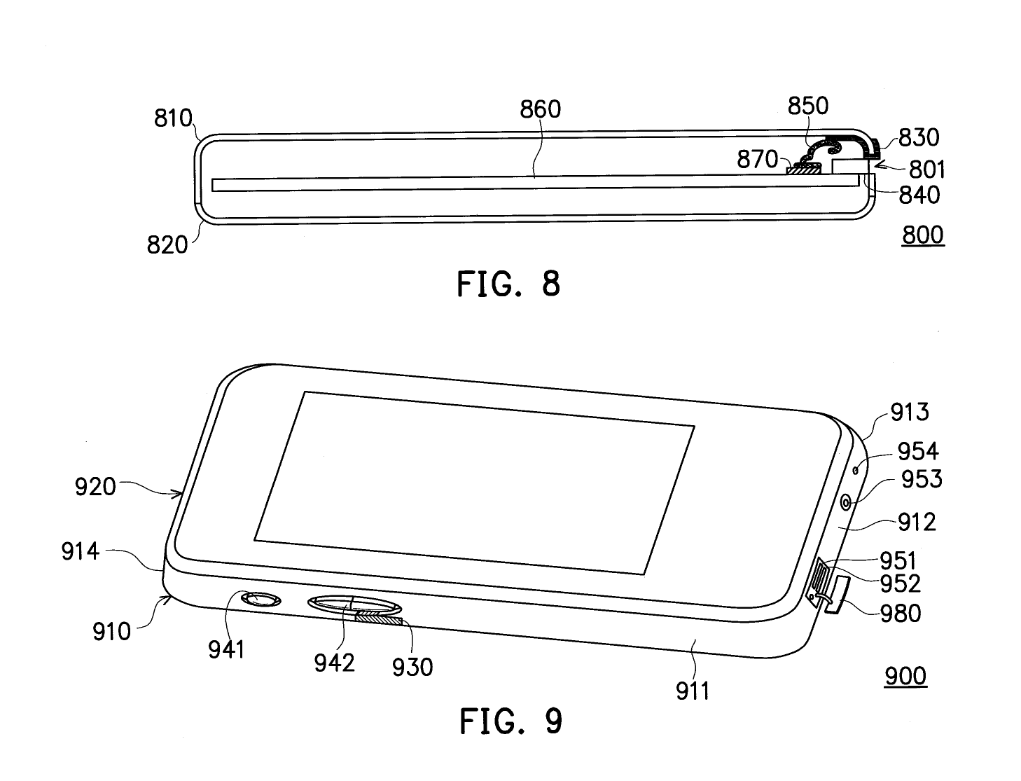

In addition, any communicating space for connecting inside and outside of the appearance 20 may be applied in the invention. FIG. 8 is a side view of a handheld device according to another embodiment of the invention. Referring to FIG. 8, a handheld device 800 at least includes an appearance 810, an appearance 820, a planar antenna 830, a functional element 840, a conductive element 850 and a substrate 860. The appearance 810 is engaged with the appearance 820 to form an accommodating space. The functional element 840, the conductive element 850 and the substrate 860 are disposed within the accommodating space, and the functional element 840 and the conductive element 850 are disposed on the substrate 860, wherein the substrate 860 may also be regarded as the system ground plane in the previous embodiment, and the handheld device 800 may at least include one planar antenna 830.

For instance, the appearance 810 has a communicating space 801, and the communicating space 801 passes through the appearance 810. In addition, the planar antenna 830 is disposed on an external surface of the appearance 810, and extended to an internal surface of the appearance 810 through the communicating space 801. In this way, the planar antenna 830 may be coupled to a feeding point and/or ground point disposed within the appearance 810 directly through the conductive element 850. Similarly, the appearance 820 may also has a communicating space, and the communicating space passes through the appearance 820. The planar antenna 830 is then disposed on the appearance 820, and coupled to a feeding point and/or ground point within the appearance 820 through the communicating space and the conductive element.

For instance, the planar antenna 830 may, for example, be a monopole antenna or a slot antenna. As shown in FIG. 8, the planar antenna 830 has a feeding portion, and the feeding portion may be electrically connected to the feeding point 870 within the appearance 810 through the conductive element 850. The conductive element 850 may, for example, be a spring or a pogo pin. In addition, in another embodiment, the planar antenna 830 may also, for example, be a loop antenna or an inverted-F antenna. Now, the planar antenna 830 has the feeding portion and a ground portion, and the feeding portion and the ground portion may respectively be electrically connected to the feeding point and the ground point within the appearance 810 through a conductive element.

The various types of antenna described above may be disposed on the appearance 810 and/or 820 through a coating technique. The coating technique, for example, is a molded interconnect device (MID) technique or a laser direct structuring (LDS) technique. As a result, the planar antenna 830 does not occupy any space in the handheld device 800. Moreover, the feeding point and the ground point are disposed on the substrate 860, and the planar antenna 830 is electrically connected to the substrate 860 through the conductive element and the feeding point/ground point.

In addition, the communicating space 801 on the appearance 810 may further be configured to expose the functional element 840, or the communicating space 801 on the appearance 810 may further be used as a channel for transmitting signals from the functional element 840. The signals may be a radio wave signal, an electromagnetic wave signal, a flashlight signal, a sound signal, a control signal, a telecommunications/electronic signal, or a power signal . . . etc. In other words, the communicating space 801 disposed on the appearance 810 on the basis of the functional element 840 may further be used as the communicating structure of the planar antenna 830.

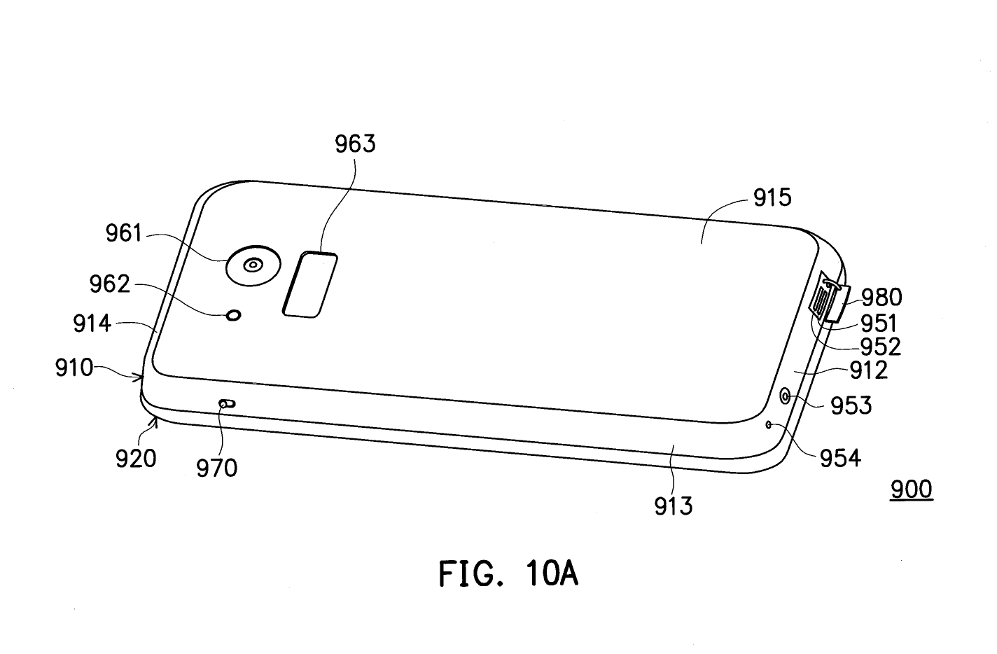

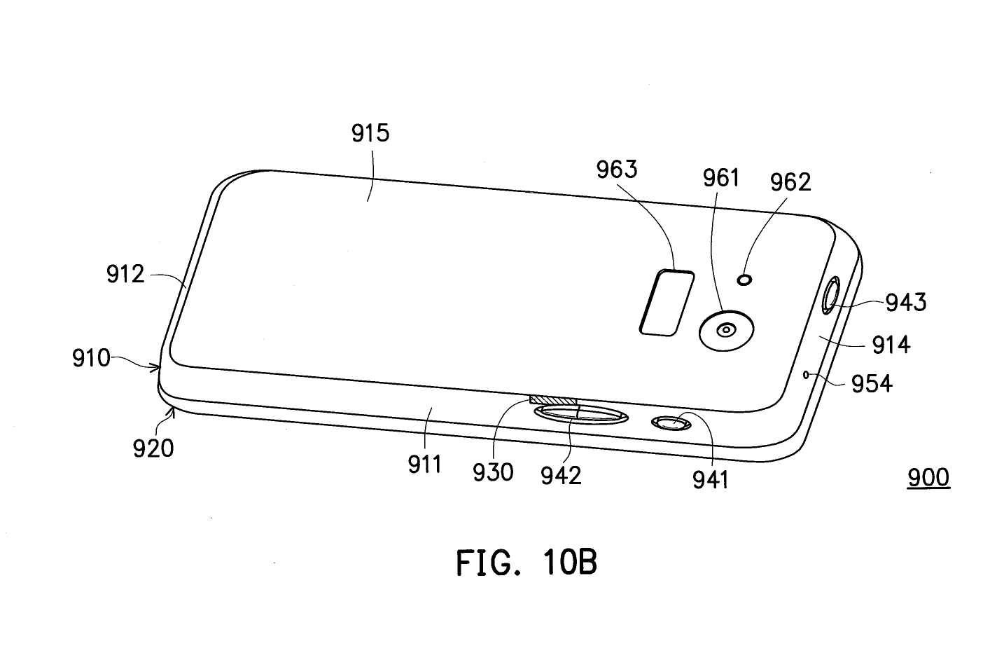

FIG. 9 is a front view of a handheld device according to an embodiment of the invention, and FIG. 10A and FIG. 10B respectively are back views of a handheld device according to an embodiment of the invention. Referring to FIG. 9, FIG. 10A and FIG. 10B, a handheld device 900 at least includes an appearance 910, an appearance 920 and a planar antenna 930. The appearance 920, for example, is a side frame of a display or a frame of a supporting element for supporting the display, and the appearance 910, for example, is a housing of the handheld device 900 or a part of the housing. The appearance 910 is engaged with the appearance 920. For instance, the planar antenna 930 may be disposed on the appearance 910. In addition, the appearance 910 has a plurality of side portions 911 to 914 and a body portion 915, wherein the body portion 915 may be a back cover or a battery cover of the handheld device 900. The body portion 915 has a plurality of communicating spaces for respectively exposing a plurality of functional elements, such as: camera module 961, flashlight module 962, fingerprint identification module 963, touch module (not shown), near field communication module (not shown) and so forth.

Moreover, the side portions 911 to 914 of the appearance 910 are also respectively have a plurality of communicating spaces for respectively exposing a plurality of functional elements, such as: buttons, connectors or switches. Specifically, the side portion 911 of the appearance 910 is configured with a plurality of communicating spaces for exposing and placing a plurality of buttons, such as: camera shutter button 941, volume control button 942 and other various types of button. In addition, the side portion 912 of the appearance 910 is configured with a plurality of communicating spaces, and the communicating spaces include at least one open slot or at least one via for exposing a plurality of connectors or being a channel for transmitting signals, such as: memory slot 951, subscriber identification module card slot 952, audio jack 953, sound-input hole 954 of a microphone and other various type of connector and via. Furthermore, the side portion 913 of the appearance 910 is configured with at least one communicating space for exposing and placing a switch 970. For instance, the side portion 914 of the appearance 910 is at least configured with a communicating space for exposing and placing a power button 943. The various types of functional element described above may be disposed at any position on the handheld device 900 based on the design requirement, and the invention is not limited thereto. When the implementation aspect of the communicating space is an open slot, the functional element is disposed within the open slot.

The planar antenna 930 extends to an internal surface of the appearance 910 through the communicating space configured to expose the volume control button 942. In this way, similar to the embodiment shown in FIG. 8, the planar antenna 930 extended to the internal surface of the appearance 910 may be coupled to a feeding point and/or ground point within the appearance 910 through a conductive element.

Although the embodiment of FIG. 9 has demonstrated an implementation of extending the planar antenna 930 to the internal surface of the appearance 910, the invention is not limited thereto. For instance, in another embodiment, the planar antenna 930 may also extend to the internal surface of the appearance 910 through a communicating space configured to expose the camera shutter button 941, the volume control button 942, the power button 943, the memory slot 951, the subscriber identification module card slot 952, the audio jack 953, the camera module 961, the flashlight module 962, the fingerprint identification module 963 or the switch 970.

Referring to FIG. 9, FIG. 10A and FIG. 10B again, the planar antenna 930 is disposed on the side portion 911 of the appearance 910. In addition, the appearance 910 further includes a cover 980 on the side portion 912. The cover 980 is detachably assembled to the side portion 912 of the appearance 910, so as to open or close the communicating spaces for exposing the memory slot 951 and the subscriber identification module card slot 952. Although the embodiment of FIG. 9 has demonstrated the configuration of the planar antenna 930, the invention is not limited thereto. For instance, in another embodiment, the planar antenna 930 may also be disposed on the body portion 915 of the appearance 910. In addition, in another embodiment, the planar antenna 930 may also be disposed on the cover 980. It should be noted that the communicating spaces used to extend the planar antenna 930 from the external surface to the internal surface of the appearance 910 does not require to drill an additional hole, because the design of these communicating spaces has been adopted by conventional functional elements, and thus integrity and aesthetics of the appearance may be retained, the fabrication process can be simplified, and the fabrication cost can be reduced.

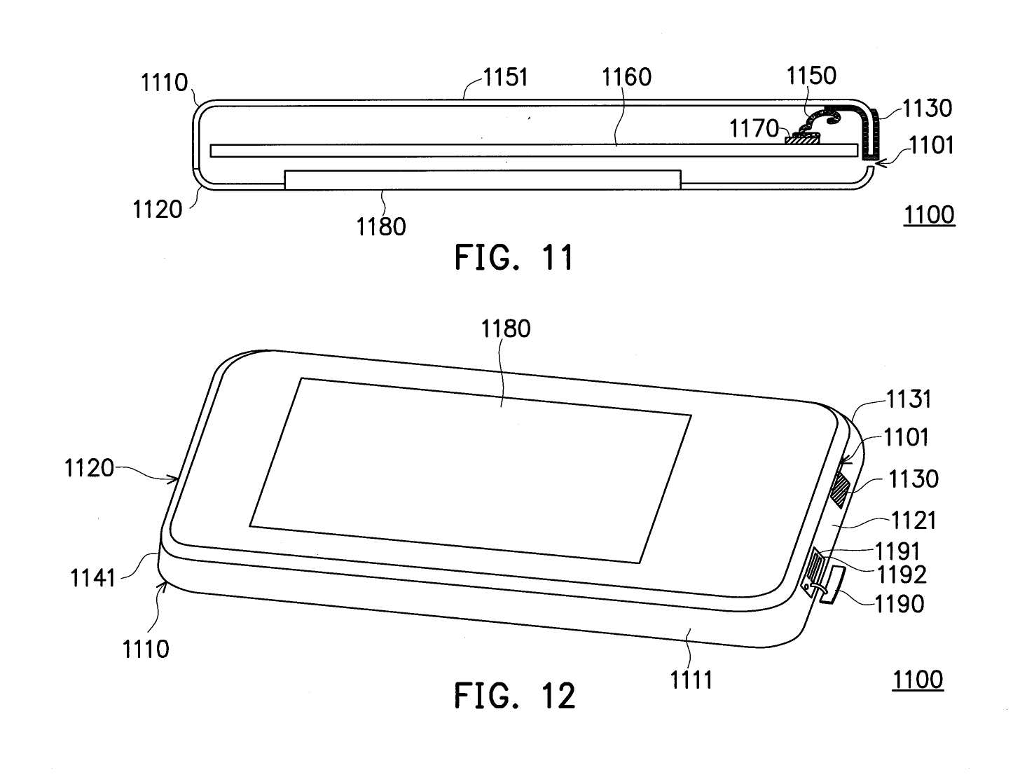

It should be noted that the gap between the two appearances 910 and 920 may also connect inside and outside of the appearance 910. Therefore, in another embodiment, the planar antenna may also extend to the internal surface of at least one of the appearance through the gap between the appearances. FIG. 11 and FIG. 12 are respectively a side view and a front view of a handheld device according to another embodiment of the invention.

Referring to FIG. 11 and FIG. 12, a handheld device 1100 comprises at least an appearance 1110, an appearance 1120, a planar antenna 1130, a conductive element 1150, a substrate 1160 and other functional elements not shown in FIG. 9. The appearance 1110 is engaged with the appearance 1120 to form an accommodating space, and the appearance 1110 has a plurality of side portions 1111 to 1114 and a body portion 1151, wherein the body portion 1151 may be a back cover or a battery cover of the handheld device 1100. The conductive element 1150 and the substrate 1160 are disposed within the accommodating space, and the conductive element 1150 is disposed on the substrate 1160. In addition, the appearance 1120 and the touch display module 1180 are assembled together.

It should be noted that a side portion 1121 of the appearance 1110 and a side portion of the appearance 1120 have a gap 1101 therebetween. In addition, the planar antenna 1130 is disposed on an external surface of the appearance 1110, namely, on the side portion 1121, and extended to the internal surface of the appearance 1110 through the gap 1101. In other words, the planar antenna 1130 extends from the external surface of the appearance 1110 to the internal surface of the appearance 1110 through the gap 1101. As such, the planar antenna 1130 may be coupled to the feeding point and/or ground point within the appearance 1110 directly through the conductive element 1150.

For instance, as shown in FIG. 11, the planar antenna 1130 has a feeding portion, and the feeding portion may be electrically connected to the feeding point 1170 within the appearance 1110 through the conductive element 1150. The conductive element 1150 may, for example, be a spring or a pogo pin. In addition, in another embodiment, the planar antenna 1130 has the feeding portion and the ground portion, and the feeding portion and the ground portion may respectively be electrically connected to the feeding point and the ground point within the appearance 1110 through a conductive element, and the feeding point and the ground point are both disposed on the substrate.

The planar antenna 1130 is disposed on the side portion 1121 of the appearance 1110. Although the embodiment of FIG. 11 and FIG. 12 has provided the configuration of the planar antenna 1130 as an example, this configuration is not intended to limit the invention. For instance, in another embodiment, the planar antenna 1130 may also be disposed at the body portion 1151 of the appearance 1110. In addition, as shown in FIG. 11 and FIG. 12, the appearance 1110 further includes a cover 1190. The cover 1190 is detachably assembled to the side portion 1121 of the appearance 1110, so as to open or close the communicating space configured to expose slots 1191 and 1192. In another embodiment, the planar antenna 1130 may also, for example, be disposed on the cover 1190.

As described above, in the invention, a planar antenna is integrated with an appearance, and the appearance has a communicating space with respected to a functional element or has a gap. As such, the planar antenna may be extended to an internal surface of the appearance through the communicating space or the gap of the appearance, and thus the signal reception quality of the planar antenna can be improved. In addition, embodiments of the invention further have following advantages:

1. a conductive element is disposed such that the electrical connection between the system ground plane and the planar antenna will not be damaged when the appearance is disassembled.

2. the communicating space of the appearance may be used as the channel for transmitting signals (such as a sound-input hole, a sound-output hole, a channel for radio wave signal, a channel for electromagnetic wave signal, a channel for flashlight signal, a channel for sound signal, a channel for control signal, a channel for telecommunications/electronic signal, or a channel for power signal) or configured to expose the functional element. In addition, the communicating space of the appearance may further be used as the connecting structure of the planar antenna. In other words, the communicating space of the appearance may have dual-use without requiring to drill additional hole for the planar antenna, and thus the fabrication process can be simplified and the fabrication cost can be reduced.

3. the planar antenna is integrated with the appearance so that the planar antenna itself does not occupy any space in the handheld device.

4. a passivation layer is disposed on the planar antenna or the planar antenna is buried in the appearance, so that the planar antenna is protected from interference or damage caused by hand touching.

5. the passivation layer or the appearance covering the planar antenna can be made of a transparent or a semi-transparent material so that the shape of the planar antenna can be seen from outside the handheld device.

6. the pattern of the planar antenna can be decorated by using a coating material so that the planar antenna can present a modern or aesthetic pattern.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A handheld device at least comprising:
a functional element;
an appearance at least comprising a communicating space, wherein the communicating space passes through the appearance, and the communicating space is a channel for transmitting signals from the functional element or the communicating space is configured to expose the functional element; and
a planar antenna disposed on an external surface of the appearance, and extended to an internal surface of the appearance through the communicating space.

2. The handheld device according to claim 1, wherein the communicating space is a via, and the via is opposite to the functional element.

3. The handheld device according to claim 2, wherein the via is a sound-output hole, a sound-input hole or an audio jack.

4. The handheld device according to claim 1, wherein the communicating space is an open slot, and the functional element is disposed within the open slot.

5. The handheld device according to claim 4, wherein the functional element is a connector.

6. The handheld device according to claim 5, wherein the connector is a memory slot or a subscriber identity module card slot.

7. The handheld device according to claim 1, wherein the functional element is a button, a switch, a camera module, a flashlight module or a fingerprint identification module.

8. The handheld device according to claim 1, wherein the appearance comprises a body portion and a plurality of side portions.

9. The handheld device according to claim 8, wherein the communicating space passes through the body portion or one of the side portions.

10. The handheld device according to claim 1 further comprising a conductive element, and the planar antenna is electrically connected to a feeding point through the conductive element.

11. The handheld device according to claim 10 further comprising a substrate disposed within the appearance, wherein the feeding point is disposed on the substrate, and the planar antenna is electrically connected to the substrate through the conductive element and the feeding point.

12. The handheld device according to claim 10, wherein the conductive element is a spring or a pogo pin.

13. The handheld device according to claim 1, wherein the planar antenna is disposed on the appearance through a coating technique.

14. The handheld device according to claim 1, wherein the appearance further comprises a cover, the cover is detachably assembled to side portions of the appearance so as to open or close the communicating space, and the planar antenna is disposed on the cover.

15. A handheld device at least comprising:
a first appearance;
a second appearance engaged with the first appearance to form an accommodating space, wherein a side portion of the first appearance and a side portion of the second appearance have a gap therebetween; and
a planar antenna disposed on an external surface of the first appearance, and extended to an internal surface of the first appearance through the gap.

16. The handheld device according to claim 15 further comprising a conductive element, and the planar antenna is electronically connected to a feeding point through the conductive element.

17. The handheld device according to claim 16 further comprising a substrate disposed within the first appearance, wherein the feeding point is disposed on the substrate, and the planar antenna is electronically connected to the substrate through the conductive element and the feeding point.

18. The handheld device according to claim 15, wherein the first appearance comprises a body portion and a plurality of side portions.

19. The handheld device according to claim 15, wherein the planar antenna is disposed on the first appearance through a coating technique.

20. The handheld device according to claim 15, wherein the first appearance comprises a cover, the cover is detachably assembled to the first appearance, and the planar antenna is disposed on the cover.
